(19) United States
(12) Patent Application Publication
(10) Pub. No.: US 2024/0391215 A1
(43) Pub. Date: Nov. 28, 2024

(54) COMPOSITE GLASS, ESPECIALLY FOR A VEHICLE

(71) Applicants: Schott AG, Mainz (DE); SCHOTT Technical Glass Solutions GmbH, Jena (DE)

(72) Inventors: Thilo Zachau, Jena (DE); Yvonne Menke-Berg, Mainz (DE); Hubert Wieseke, Jena (DE)

(73) Assignees: Schott AG, Jena (DE); SCHOTT Technical Glass Solutions GmbH, Jena (DE)

(21) Appl. No.: 18/671,416

(22) Filed: May 22, 2024

(30) Foreign Application Priority Data
May 23, 2023 (DE) 10 2023 113 419.1

(51) Int. Cl. B32B 17/10; C03C 3/066; C03C 3/091; C03C 3/093; C03C 8/02; C03C 8/04; C03C 17/02

(52) U.S. Cl. CPC B32B 17/10119; B32B 17/10036; B32B 17/10651; B32B 17/10761; C03C 3/066; C03C 3/091; C03C 3/093; C03C 8/02; C03C 8/04; C03C 17/02; B32B 2255/20; B32B 2307/546; B32B 2307/558; B32B 2605/00; C03C 2217/213; C03C 2217/216; C03C 2217/228; C03C 2217/23; C03C 2217/485

(57) ABSTRACT

A composite glass includes two glass panes with a glass pane having coated regions and including a glass having SiO₂ and B₂O₃ and a first side and a second side; a coating applied in at least one region of the second side, the coating taking the form of an enamel coating having at least one pigment, a vitreous constituent, and pores; and a polymeric layer disposed between the glass panes, a polymer in the polymeric layer being in uncolored form, and at least a portion of the polymeric layer in the at least one region of the coating at least partly fills the pores of the coating so a color locus of the composite glass in the at least one region in which the coating is applied given in the CIEL*a*b* system where L* is at most and a* and b* are each in a range between +5 and −5.

### CROSS REFERENCE TO RELATED APPLICATIONS

This application claims priority to German Patent Application No. 10 2023 113 419.1 filed on May 23, 2023, which is incorporated in its entirety herein by reference.

### BACKGROUND OF THE INVENTION

### 1. Field of the Invention

The invention relates generally to a composite glass, especially for a vehicle. The invention relates specifically to a composite glass, for example for a vehicle, which is suitable, for example, for use as a windscreen and has particularly good strength and very good user safety.

### 2. Description of the Related Art

Composite glasses are chosen, for example, for vehicle glazing, especially in particularly critical regions such as the windscreen. Composite glasses generally comprise at least two glass panes that are bonded to one another by a polymeric layer disposed between the panes. If mechanical action results in breakage, the polymeric layer, which may take the form of a film, for example, holds the fragments of the glass panes together, so as to reduce injuries to the vehicle occupants caused by broken glass.

Since such vehicle panes are subject to abrasive conditions, namely by particles that hit them at high speed (for example including the known “stone-chipping”), it can be advantageous to provide a pane comprising a glass having the components SiO₂ and B₂O₃ as outer glass pane of this composite pane. Such a glass is also referred to generally as borosilicate glass in the context of the present disclosure. Such glasses are known to have good scratch resistance and a number of further advantages such as generally good mechanical and thermal stability.

The use of borosilicate glass, for example, as commercially available, for example, under the Borofloat® trade name, in the outer glazing of vehicles is known. Such a glass is of very good suitability, for example, for laminate glazing and is notable for very high transmittance in the region of visible light. Moreover, borosilicate glasses in general have very good thermal stability, high chemical stability and good mechanical strength.

For example, international patent application WO 2015/059406 A describes laminated glass panes. One of these panes may comprise, for example, a borosilicate glass, for example the outer pane.

International patent application WO 2017/157660 A1 describes a composite glass pane for a head-up display. Here too, one of the panes in the composite glass may comprise borosilicate glass.

CO 2017/0005596 A1 likewise describes an automotive glass pane having high strength.

International patent application WO 2019/130285 A1 describes a laminate having high resistance to abrasion and environmental influences.

Finally, international patent application WO 2018/122769 A1 describes a laminate having high breaking strength.

As stated, windscreens are designed as composite glass panes for the safety of the vehicle occupants. They also typically have a coating in the edge region. This coating serves firstly for visual concealment, for example, of bonds or components, for example antennas, and secondly also for protection thereof from UV radiation. In general, this coating, which may thus be disposed in the form of a frame, for example, is disposed between the two glass panes of a composite. The composite further comprises, as likewise already stated above, a polymeric layer, i.e. one comprising a polymer or consisting of a polymer, between the two glass panes, which bonds the glass panes to one another. The glass panes with the coating disposed between them are frequently placed one on top of another in at least one region, especially in the edge region, and bent in a thermal forming process. In general, without restriction to this example described here, it is alternatively possible that the forming of the glass panes of a composite is also undertaken individually and separately from one another. Subsequently, a polymeric layer is introduced between the two panes, and the curved glass panes are bonded to one another, so as ultimately to obtain a composite glass pane. In the context of the present disclosure, such a composite glass pane is also referred to in simplified form as “composite glass”. The terms “glass composite” or “composite” can also be used synonymously for such composite glasses.

Therefore, a number of demands are placed on glass panes encompassed by such a composite. Since the bending processes are thermal, the glass panes and the coating applied thereto must be able to cope with these temperatures. The glass panes and the coating must be able to enter into a bond in the mould with the polymeric layer such that a stable bond is formed and there is no delamination between glass and polymer. Finally, it is necessary for the coating to have sufficient optical density in order that components disposed in the edge region of the windscreen are not visible in an unsightly manner. This prevents distraction of the vehicle driver and hence increases driving safety. Microcracks or other defects in the coating should also if possible be avoided or at least minimized.

As well as the thermal stability of glass and coating, the addressed compatibility of glass or coating with a polymeric material for the formation of a bond, the optical density and the minimization of possible defects and generally the mechanical strength of the individual glass panes (here in particular the coated glass pane), it is particularly important that the coating is particularly uniform, and is optionally dark-colored or black. In the case of coatings on glass panes, including in the frame of composite glass panes, it is common knowledge that, specifically if they have particularly good adhesion, they can impair the strength of a glass pane—and hence also ultimately the strength of the resulting glass composite. Other difficulties are that, on the one hand, layers having particularly good adhesion are desirable in order to prevent layer delamination, but on the other hand these layers having good adhesion lower the glass strength.

In order to achieve good mechanical strength of the glass pane and the resulting composite, such layers may, for example, be porous or include a sol-gel binder rather than a glass-based binder. This is because the lowering of the strength by one layer or more layers is highly likely to be based partly on the forming of a so-called “partly melted reaction zone”, which arises in the use of customary glass-based coatings. Secondly, however, the formation of very dense layers also results in lowering of strength when the thermal expansion of the layer and of the substrate is very different. This can be reduced, for example, by a porous character of the coating. This can be effected, for example, by the use of a sol-gel binder, in the case of which there is also no formation of a so-called partly melted reaction zone-which is likewise advantageous for strength.

However, a disadvantage of porous character of a coating and/or of the use of a sol-gel binder is that no particularly good glass composites were producible to date in this way. This is because the glass composite forms, as stated above, by the laminating of the at least two panes of the composite by means of a polymeric layer. Depending on the composition of a sol-gel binder, compatibility with a polymer can be reduced, such that no stable bond is possible specifically in the region of the coating. Porous coatings may also either have insufficient bond strength or lead to a very distorted, spotty appearance of the coating, which may be critical for the safety of the vehicle driver, since a distorted appearance can distract the vehicle driver.

There is thus a need for composite glasses that at least alleviate the aforementioned weaknesses of the prior art.

### SUMMARY OF THE INVENTION

In some embodiments provided according to the disclosure, a composite glass includes: two glass panes, at least one glass pane being a glass pane having coated regions and including a glass comprising SiO₂ and B₂O₃ and having a first side and a second side; at least one coating applied in at least one region of the second side of the at least one glass pane, the at least one coating taking the form of an enamel coating comprising at least one pigment and a vitreous constituent, the at least one coating having pores; and at least one polymeric layer disposed between the glass panes. A polymer in the at least one polymeric layer is in uncolored form and at least a portion of the at least one polymeric layer in the at least one region of the at least one coating at least partly fills the pores of the at least one coating so as to result in a color locus of the composite glass, determined in viewing direction from the first side to the second side of the at least one glass pane, in the at least one region in which the at least one coating has been applied on the second side of the at least one glass pane, given in the CIEL*a*b* system where L* is at most and a* and b* are each in a range between +5 and −5.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawing(s), wherein:

FIG. 1 is a schematic diagram, not to scale, of a section through a composite glass provided according to one embodiment;

FIG. 2 is a schematic diagram, not to scale, of a glass pane provided according to one embodiment;

FIG. 3 is a schematic top view, not to scale, of a composite glass provided according to one embodiment; and

FIGS. 4 to 7 are scanning electron micrographs of glass panes having at least one coating in the laminated and unlaminated state.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

The invention generally relates to a composite glass, especially for a vehicle, comprising two glass panes, wherein at least one glass pane is a glass pane having coated regions and comprising a glass comprising SiO₂ and B₂O₃ and having a first side and a second side.

At least one coating has been applied at least in at least one region of the second side of the at least one glass pane.

The at least one coating takes the form of an enamel coating comprising at least one pigment, a vitreous constituent and optionally at least one additive. The additive may especially take the form of a filler.

The at least one coating comprises pores, optionally open pores, so as to result optionally in a direct connection in the at least one coating between a side of the at least one coating facing the second side of the at least one glass pane and a side of the at least one coating remote from the second side of the at least one glass pane.

The at least one glass pane optionally has a flexural strength between at least 5 and at most 170 MPa, optionally at least 20 and at most 170 MPa, optionally at least 35 MPa, optionally at least 60 MPa, and optionally at least 80 MPa.

The composite glass further comprises at least one polymeric layer disposed between the glass panes, wherein a polymer in the polymeric layer is in uncolored form, and wherein at least a portion of the polymeric layer in the region of the at least one coating at least partly fills the pores of the at least one coating.

The result is thus a color locus of the composite glass, given in the CIEL*a*b* system, determined in viewing direction from the first side to the second side of the at least one glass pane, in the at least one region in which the first coating has been applied on the second side of the at least one glass pane, where L* is at most 12 and optionally at least 1, and A* and b* are each in the range between +5 and −5. In other words, the color locus is thus measured or determined through the glass pane.

The following definitions are applicable in the context of the present disclosure:

A composite glass is generally understood to mean a composite comprising at least two glass panes that are firmly bonded to one another by means of an intermediate layer. A composite glass can generally also be referred to as “composite”, “composite pane”, “glass composite”, “composite glass pane” or the like.

A pane is generally understood to mean a shaped body having a lateral dimension in a first spatial direction of a Cartesian coordinate system which is at least one order of magnitude lower than the lateral dimensions in the two other spatial directions at right angles to the first spatial direction. This lateral dimension along the first spatial direction can generally also be referred to as “thickness” of the pane, and the two other lateral dimensions as “length” and “width”. In other words, in a pane in the context of the present disclosure, the thickness is at least one order of magnitude lower than the length and width thereof. In the context of the present disclosure, the length and width of the pane may be in the same order of magnitude, or the length of the pane may be much greater than the width. Therefore, a pane in the context of the present disclosure also includes a configuration as a continuous strip.

A glass pane is generally understood to mean that the pane comprises a glass, for example is formed from glass. A glass pane may generally be in coated form, i.e. take the form of a coated glass pane.

The sides of a glass pane in the context of the present disclosure are understood to mean a main face or main surface. As stated above, a pane is a shaped body where the thickness is much lower than the length and the width. Length and width of such a pane-shaped shaped body (or a pane) define the main faces that together account for more than 50% of the total surface area, frequently also much more, specifically in the case of very thin panes. The main faces or sides thus contrast with the circumferential edge faces of the pane. In general, a pane in the context of the present disclosure thus comprises two sides which may also be referred to accordingly as top side and bottom side or front side and reverse side.

In the context of the present disclosure, the terms “layer” and “coating” are understood synonymously in the sense that a layer is understood to mean a material layer which is applied by a specific method (a so-called coating method) to a substrate of a usually different composition from the material of the coating or layer. Such coating methods in the context of the present disclosure may especially be coating methods such as printing, optionally screenprinting or pad printing, painting, rolling, applying as a film, or knife-coating, but dipping and spraying or other further coating methods are also generally conceivable. It is generally conceivable to apply a coating or material layer in the form of a lamination as well, for example by lamination of a film. The polymeric layer of the composite can therefore generally be regarded in the context of the present disclosure as a material layer within the scope of the disclosure.

An enamel coating in the context of the present disclosure is generally understood to mean a coating comprising at least one vitreous constituent that adheres on a substrate via a thermal process. The enamel coating may, as well as the vitreous constituent, comprise further constituents, especially at least one pigment and optionally one or more additives, for example one or more fillers or what is called a blowing agent. A vitreous constituent in the present context is understood to mean a constituent which is inorganic and amorphous, especially comprising SiO₂. In particular, the vitreous constituent may have originated from a melting process or have been formed from glass. In general, a glass is understood to mean an inorganic, amorphous solid obtained from a melting process. In general, it is a silicatic glass. The vitreous constituent of the enamel coating may especially take the form of a glass flux or glass frit. These terms are known to the person skilled in the art in the field of glass coating. The enamel coating in the context of the present disclosure may be of such a form that the vitreous constituent has fully melted, flows to the underlying substrate, i.e. the glass pane in particular here, and envelops other constituents of the coating, for example pigment particles, although it is also possible that the enamel coating takes the form of a sintered coating, which means that the vitreous constituent is merely partially melted in the thermal process (which can also be referred to as baking). This may be preferable particularly when the aim is a layer comprising pores.

A pigment in the context of the present disclosure is understood to mean a colored body, i.e. a solid having an intrinsic color. This is typically in particle form. Thus, if a coating in the context of the present disclosure comprises a pigment, this means that the coating comprises particles of a solid having a particular composition. This is also correspondingly true of what are called fillers. Fillers are solids that are added in particulate form to a coating or a layer, in order to affect particular properties of the coating, where the fillers do not relate primarily to the color of the coating but relate to other properties, for example thermal expansion, scratch resistance or the like.

A polymeric layer is understood to mean a material layer comprising or composed of a polymer. In particular, the polymeric layer may take the form of a polymer film. A polymer is an organic macromolecule. When it is said in the context of the present disclosure that a layer or a film is “composed of” a particular polymer, this means that this layer comprises that polymer as an essential constituent, but—as is generally customary in the plastics industry—may also include other constituents that can be referred to as so-called admixtures.

An “uncolored” form of a material or a material layer means that this is in colorless form in the visible light region, i.e. from 380 nm to 780 nm, i.e. has a neutral color locus and optionally has high transparency in this wavelength range. Transmittance (τᵥᵢₛ) in this wavelength range is optionally at least 70% or more in order to meet requirements that enable, for example, use of a composite pane as windscreen. Minimum transmittance for windscreens is generally more than 70%. Dazzle reduction wedges in the upper secondary viewing region are permissible for attenuation of glare, provided that these occur over an area of less than 0.1 m². The formation of such regions for attenuation as a gradient to 0% transmittance at the edge of the pane is possible. The relevant standard in Europe is ECE R43 (Regulation No 43 of the Economic Commission for Europe of the United Nations (UN/ECE)—Uniform provisions concerning the approval of safety glazing materials and their installation on vehicles—Official Journal of the European Union L 42/1; Mar. 11, 2013).

A layer or coating comprising pores is understood to mean a coating in porous form. In particular, this may be understood to mean a coating having open porosity, optionally even with continuous pores. Continuous pores or continuous porosity is understood to mean that there are fluid channels that connect the first side of a material layer to a second, opposite side of the material layer from the first side.

One configuration of a composite glass as described above has a number of advantages, which will be discussed by way of example hereinafter.

The composite glass comprises at least two glass panes, where at least one glass pane is a glass pane comprising a glass comprising SiO₂ and B₂O₃, i.e. takes the form of a borosilicate glass pane. Such a glass pane, as also already discussed above, has good mechanical strength (especially breaking strength), high thermal stability and also good scratch resistance (which can also be regarded as, and is systematically similar to, resistance to attack by small, sharp articles). The chemical stability of these glasses is also very marked by comparison, for example, with soda-lime glasses. This is also of particular relevance for vehicle glazing since this can be exposed to salt spray mist in the winter, for example, which can also lead to so-called glass corrosion. The higher chemical resistance of borosilicate glasses may be advantageous here over known soda-lime glasses.

At least one coating is disposed in at least one region of the at least one pane composed of or comprising a borosilicate glass. This is generally understood here to mean that the composite glass comprises at least one coating, where it may especially also be the case that the composite glass comprises just a single coating. It is alternatively possible and may be the case that the composite glass comprises further coatings. These may be disposed in the region having the at least one coating or may partly overlap therewith, but this is not absolutely necessary.

The at least one coating is a coating having the purpose of acting as a kind of optionally opaque region, optionally in the edge region of the at least one glass pane, or in a corresponding manner of the composite glass, for example as a kind of lamination of wires or the like, but also to some degree as a sunshield or anti-dazzle feature for vehicle occupants, for example a vehicle driver. In some embodiments, the at least one coating may take the form of a frame, i.e. of a circumferential region around the edge of one side of the glass pane.

For this purpose, the at least one coating takes the form of a pigmented coating, i.e. in colored form. The at least one pigment encompassed by the at least one coating ensures that the coating has sufficient optical density that electronic components are not visible in an unsightly manner and/or that the coating is able to fulfil its function as shade/anti-dazzle feature. The at least one coating takes the form of an enamel coating at least comprising, as stated, a pigment and a vitreous constituent. Such enamel coatings not only have good chemical and mechanical stability because of their vitreous character but also have good compatibility with a vitreous substrate, such as the glass pane in question here, and so it is generally also possible in this way to achieve a relatively good bond strength.

The glass pane, especially by virtue of the formation of the at least one coating itself, may optionally take such a form that it has a flexural strength between at least 5 and at most 170 MPa, optionally at least 20 and at most 170 MPa, optionally at least 35 MPa, optionally at least 60 MPa, and optionally at least 80 MPa. The coating and/or the at least one glass pane is thus optionally such that the inherent strength of the glass pane is maintained or only slightly lowered.

As stated, the composite glass comprises a polymeric layer disposed between the glass panes, where a polymer in the polymeric layer is uncolored. In other words, the plastic in the polymeric layer and hence the polymeric layer overall is in transparent form. This is of course not just advantageous but indeed absolutely necessary in the viewing region of a vehicle pane. In the case of known prior art composite glasses, however, it is also known that the polymeric layer can be colored in the region of the at least one coating. In the case of prior art composite glasses, it may be the case, for example, that there is disposed in the edge region, i.e., for example, the region of the at least one coating, a polymeric layer that simulates this frame and is itself colored. There is then in turn, for obvious reasons, an uncolored polymeric layer disposed in the viewing region. Thus, in order to enable sufficient transparency of the composite glass in the viewing region, but at the same time also to create sufficient opacity in the edge region, therefore, there is sometimes a need in the prior art for two different polymeric layers, for example two different polymer films.

This is unnecessary according to the present disclosure; instead, it is optionally the case that a polymeric uncolored layer is formed between the panes of the composite glass. In particular, this is optionally also uncolored in the region of the at least one coating. For example, it may be the case that the polymeric layer is disposed across the whole area between the two glass panes.

It is of course possible for other reasons, for example better bond strength of a particular polymer on a coating, to also follow a “two films” or “two polymers” solution in the present disclosure.

Nevertheless, the composite glass provided according to the present disclosure enables a uniform, dark color locus of the composite glass, determined in viewing direction from the first side to the second side of the at least one glass pane in the at least one region in which the at least one coating is disposed, specifically also when just a single polymeric layer is used, disposed over the whole area between the glass panes. This is possible because the at least one coating is porous, optionally with open, continuous porosity, and because at least some of the polymeric layer in the region of the at least one coating at least partly fills the pores of the at least one coating.

The effect of the porous character of the at least one coating is that this coating does not critically impair the mechanical strength of the at least one glass pane, and lowers it only slightly for example. But this leads simultaneously to an insufficiently neutral, dark color of the coating, or in a corresponding manner of the glass composite. This is because the pores result in scatter, causing a distorted appearance, which means that sufficient concealment of components is impossible and the vehicle occupant may be distracted. This is unfavorable for safety reasons. However, the specific character of the coating with open pores having optionally continuous porosity, as described above, means that constituents of the polymeric layer can at least partly fill the pores. “Constituents of the polymeric layer” does not mean here that individual components of the polymeric layer enter the pores, but that the polymeric layer is partly drawn into the pores and at least partly fills them. This can be accomplished, for example, when the polymeric layer is disposed between the glass panes in the course of formation of the glass composite, for example in the form of a film, and the viscosity of the polymeric layer becomes so low during the laminating operation that it is drawn into the pores on account of capillary forces. In some embodiments, this can be done in the mold, in that the pores are filled essentially completely, i.e. to an extent of at least 80% by volume, by the polymeric layer, in some cases even to an extent of more than 80% by volume. However, it is generally difficult to prepare the composite glasses such that a corresponding determination of the fill level is possible analytically.

The filling of the pores with a polymeric (or plastics) material can surprisingly also achieve a uniform, very dark color locus even when the polymer of the polymeric layer is itself not colored at all. This obviates the need to provide two different polymeric layers, namely a colored layer for the region of the at least one coating and an uncolored/transparent layer in the “viewing region” of the composite glass. This very exceptionally simplifies the production of a composite glass.

In this way, it is then very simple to achieve a color locus of the composite glass, determined in viewing direction from the first side to the second side of the at least one glass pane, in the at least one region in which the at least one coating has been applied on the second side of the at least one glass pane, given in the CIEL*a*b* system, where L* is at most 12 and optionally at least 1, and a* and b* are each in the range between +5 and −5.

The polymeric layer optionally comprises polyvinylbutyral (PVB) or takes the form, for example, of a so-called PVB film.

In some embodiments, the polymeric layer may have a thickness between 650 μm and 850 μm. Typical thicknesses of illustratively suitable films are, for example, 700 μm and 760 μm.

In some embodiments, the at least one coating may have a thickness between 2 and 10 mm, for example up to at most 7 μm.

The at least one pane comprising a borosilicate glass may optionally be a floated glass pane. The at least one coating in this case has optionally been applied on what is called the atmosphere side of the glass pane.

In some embodiments, the transmittance, τᵥᵢₛ, determined in the at least one region, is less than 5%, optionally less than 2%, optionally less than 1% and optionally less than 0.5%. The transmittance is of course achieved where the at least one coating has been applied over the full area. The low transmittance shows that, in this embodiment, there is a very high shadowing and hiding effect of the at least one coating.

In general, it is pointed out that the at least one coating is frequently applied around the edge of the at least one glass pane and hence correspondingly also around the edge of the composite glass. It may be the case here that there is a bulge in particular regions, for example in the region in which a rear-view mirror is disposed in the case of a windscreen. It may also be the case that, in the regions toward the interior of the composite glass, the frame applied over the full area merges into a region with a degree of coverage in which the coating is applied in the form of a dot pattern with a lower degree of coverage. This is entirely customary, for example, in windscreens in the vehicle sector.

In some embodiments, the pigment content of the at least one coating is between 1% by volume and 40% by volume, optionally less than 37.5% by volume, generally with an exemplary lower limit of 5% by volume. In this way, it is possible to achieve visually colored, dark coatings, with simultaneous assurance that there will still be sufficient bond strength of the coating on the substrate, i.e. the glass pane here.

In some embodiments, this may be advantageously supported in that the content of vitreous constituent in the at least one coating, based on the solids content of the at least one coating, is between 60% by volume and 99% by volume, optionally between 62.5% by volume and 95% by volume. The solids content lacking from 100% by volume may especially be formed by at least one pigment, and there may optionally be additional further constituents, for example a filler or else two or more fillers, and likewise optionally further pigments.

If the composition of the at least one coating is reported not in % by volume but in % by weight, this with regard to the pigment content of the at least one coating is between about 1% by weight and 60% by weight of pigment. The content of vitreous constituent in the at least one coating is about 35% by weight to about 98% by weight. If the at least one coating includes an additive in the form of a filler, contents in % by weight of between 1% by weight and 15% by weight are possible. These figures, like the % by volume figures as well, are each based on the solids content of the at least one coating, and hence are correspondingly also applicable to the solids content of a paste that can be used for production of a corresponding at least one coating of a glass pane in embodiments.

In some embodiments, the at least one coating, as well as at least one pigment and the vitreous constituent, comprises an additive. It is of course possible that the at least one coating comprises two or more additives that are different. The additive may take the form, for example, of a filler, for example of a filler that increases scratch resistance or influences the thermal expansion of the coating. It is also possible that the additive is a blowing agent, which can also be referred to as pore former or foaming agent. Such a blowing agent breaks down when the at least one coating is baked, forming gas that contributes to the formation of pores and especially promotes the development of open porosity as well, which may be particularly advantageous here, in an advantageous manner. An additive in the form of a blowing agent may be added in corresponding amounts to an additive in the form of a filler to a paste for production of at least one coating in embodiments, but for obvious reasons, namely breakdown, is no longer included in the solids content of the at least one coating.

In some embodiments, the vitreous constituent of the at least one coating comprises, in % by weight based on oxide:

| | |
|---|---|
| SiO₂ | 10 to 70 |
| B₂O₃ | 5 to 30, optionally 6 to 25. |

In other words, the vitreous constituent (or glass flux or glass frit) in this embodiment itself is designed as comprising a borosilicate glass. This may be advantageous because a high compatibility between the glass flux and the at least one glass pane to which the at least one coating has been applied in regions is possible in this way.

In addition, it may generally be the case that the vitreous constituent also comprises Al₂O₃, optionally in an amount of less than 10% by weight.

Depending on the exact emphasis, the glass flux or the vitreous constituent in further embodiments may be different within the scope specified.

For example, it is possible that the vitreous constituent of the at least one coating comprises, in % by weight based on oxide:

| | |
|---|---|
| SiO₂ | 10 to 50 |
| B₂O₃ | 10 to 26 |
| ZnO | 20 to 50, |

where the sum total of the alkali metal oxides (R₂O) is optionally between less than 0.5% by weight and 10% by weight and/or the sum total of the alkaline earth metal oxides is between 0% by weight and 2.5% by weight.

In this case, the glass flux thus takes the form of a zinc borate glass flux. This may be advantageous because this lowers the melting temperature of the frit and hence there is sufficient flowability at baking temperatures (500-750° C.) in spite of the pigment and filler content.

In another embodiment, the vitreous constituent of the at least one coating comprises, in % by weight based on oxide,

| | |
|---|---|
| SiO₂ | 30 to 60 |
| B₂O₃ | 15 to 25 |
| Bi₂O₃ | 8 to 45, |

where the sum total of the alkali metal oxides (R₂O) is optionally between 3.5% by weight and 8.5% by weight, optionally between 4% by weight and 6.5% by weight, and/or the sum total of the alkaline earth metal oxides is 0.5% by weight or less. In this embodiment, the vitreous constituent optionally comprises at least 2.5% by weight of at least one oxide from the group of Li₂O, Na₂O and K₂O, where the ratio of the alkali metal oxides (R₂O) to aluminium oxide, based on the molar proportion, is generally less than 6, i.e.

$$\frac{\sum {R}_{2} O}{{Al}_{2} {O}_{3}} < 6.$$

This case thus concerns a bismuth borate glass flux. This may be particularly advantageous if an optimum between the coefficients of thermal expansion of the substrate and glass flux is to be addressed taking account of the baking temperature. In this way, it is then possible to achieve particularly good strength values.

In some embodiments, the vitreous constituent comprises, in % by weight based on oxide,

| | |
|---|---|
| SiO₂ | 50 to 70 |
| B₂O₃ | 15 to 30 |
| Bi₂O₃ | 0 to 15 |
| ZnO | 0 to 5, |

where the sum total of the alkali metal oxides is optionally between 4 and 6.5% by weight and/or the sum total of the alkaline earth metal oxides is between 0 and 2.5% by weight.

In some embodiments, the at least one coating comprises an additive in the form of a filler, where the filler optionally has a coefficient of linear thermal expansion of between −7*10⁻⁶/K and 1.5*10⁻⁶/K. The coefficient of linear thermal expansion can also be referred to as α for short, and it is also possible to report the temperature range for which the coefficient of expansion has been determined as an index. If, in the context of the present invention, thermal expansion is emphasized, this is understood to mean linear thermal expansion. The terms “coefficient of linear thermal expansion”, “coefficient of thermal expansion”, “coefficient of expansion”, “CTE” and “α” are used synonymously here in the context of the present disclosure, unless explicitly stated otherwise. In particular, the coefficient of linear thermal expansion can be determined in a method according to ISO 7991.

Fillers having a coefficient of thermal expansion within the aforementioned range are advantageous because the thermal expansion of the at least one coating, which does of course result from its constituents, can be influenced and especially reduced in this way. Since pigments generally have a comparatively higher coefficient of thermal expansion than a borosilicate glass, which is of course the substrate material provided according to the present disclosure, it may be advantageous to add a filler having a relatively low coefficient of thermal expansion to the coating, such that the resulting strength of the glass pane/the composite does not become too low.

It has thus been found in some embodiments that, in the case of addition of a filler, it is possible by controlled adjustment of the ratio of the contents of pigment and nanoparticulate filler to achieve a pane composite having good mechanical properties and high opacity. Pigments used typically have a diameter at least one order of magnitude greater than that of nanoparticulate fillers. Exemplary diameters or sizes of the pigments are also stated further down in the Examples.

In some embodiments, the at least one coating comprises an additive in the form of a filler, the content of which is between 0.5% by volume and 20% by volume, optionally less than 15% by volume.

It may optionally be the case that the at least one coating includes two fillers having different properties, for example in terms of their particle size. With regard to particle size, the emphasis in the present context is always on the equivalent diameter, based on the d₅₀ of the particle size distribution. If, therefore, merely “particle size” or “diameter” is mentioned in the context of the disclosure, unless explicitly stated otherwise, this is the d₅₀ of the particle size distribution.

Such a configuration with two fillers that differ with regard to their particle sizes may be advantageous because a particularly advantageous pore size distribution results in this way, with which the diffusion or the penetration of the polymer into the pores of the at least one coating is possible in particular in a particularly simple manner. For example, it is possible that one filler is a nanofiller, i.e. has a particle size of less than 100 nm, but another filler has a particle size at least half an order of magnitude greater than that of the nanoparticulate filler. The nanoparticulate filler may have, for example, a particle size of at most 50 nm, in which case the further filler should have a particle size of advantageously at least 0.5 μm. In this way, good porosity can be achieved particularly efficiently in the coating. Customary sizes of non-nanoparticulate fillers are about 0.5 μm to 1.5 μm.

However, it has also been found that, in the case of addition of an optionally nanoparticulate filler, i.e. a filler having a particle diameter of at most 50 nm, it may even be sufficient when no further filler is present, and the ratio of the content of pigment and nanoparticulate filler is instead well adjusted. This is because pigments used typically have a diameter at least one order of magnitude greater than that of nanoparticulate fillers. For white pigments, this is optionally 1 μm or less, optionally 0.8 μm or less, optionally 0.6 μm or less. Exemplary diameters or sizes of the pigments are also specified further down in the Examples.

In some embodiments, the at least one coating and/or the paste comprises a further additive in the form of a blowing agent. The blowing agent content of the paste with which it is possible to produce a corresponding at least one coating in embodiments for a composite glass provided according to the disclosure in this case is optionally between 5% by volume and 25% by volume, optionally less than 15% by volume.

In some embodiments, the at least one glass pane comprises at least 60% by weight and at most 85% by weight of SiO₂, at least 8% by weight and at most 26% by weight of B₂O₃, at least 0.5% by weight and at most 12% by weight of Al₂O₃ and at least 0.5% by weight and at most 6% by weight of Na₂O, and may optionally further include up to 1% by weight of Li₂O, up to 4% by weight of K₂O, up to 5% by weight of MgO, up to 3.5% by weight of CaO, 4% by weight of SrO, up to 3% by weight of ZnO, up to 3% by weight of ZrO₂, and additionally secondary constituents, for example refining agents, where the sum total of these secondary constituents is not more than 2% by weight.

SiO₂ is the primary network former and the main constituent of the glass of the at least one glass pane. In order that the glass pane is sufficiently chemically and mechanically stable, therefore, the SiO₂ content in the glass pane should be at least 60% by weight. In order to assure good fusibility, however, the SiO₂ content in the glass pane is optionally limited and in some embodiments comprises not more than 85% by weight. B₂O₃ is a further constituent of the at least one glass pane and is optionally present in the glass to an extent of at least 8% by weight. In this way, the melt viscosity of the glass can be kept low, which is favorable from a production point of view. Advantageously, the B₂O₃ content of the glass is not too high in order to obtain a sufficiently chemically stable glass. The glass further comprises at least 0.5% by weight of Al₂O₃. Al₂O₃ is what is called an intermediate oxide which is optionally added in borosilicate glasses in order to reduce the tendency to separation that exist in these glasses. It is also possible for Al₂O₃ to improve the hardness of a glass. But since it can simultaneously lower chemical stability and at the same time also increase the melting temperature, it should not be present in the glass in excessively high contents, and an exemplary upper limit here is therefore at most 12% by weight of Al₂O₃. Finally, the glass also comprises Na₂O to an extent of at least 0.5% by weight and at most 6% by weight. In this way, the melting point of the glass can be lowered further, while simultaneously ensuring that there are no excessively high Na₂O contents that would too significantly reduce the chemical stability of the glass.

Further constituents may likewise be encompassed by the glass. For example, it is possible to include up to 1% by weight of Li₂O, up to 4% by weight of K₂O, up to 5% by weight of MgO, up to 3.5% by weight of CaO, up to 4% by weight of SrO, up to 3% by weight of ZnO, up to 3% by weight of ZrO₂. These components can affect different properties of the glass, for example further counteract any tendency to separation (for example the addition of K₂O), improve the strength of the glass and the like.

The glass may of course generally comprise further secondary constituents, for example refining agents, where the sum of these secondary constituents is not more than 2% by weight. In some embodiments, the further glass pane comprises or consists of a soda-lime glass.

A soda-lime glass is generally a glass comprising, as main constituents, SiO₂, CaO and Na₂O and is produced in large volumes. It is available inexpensively, but also has certain weaknesses, for example relatively low chemical and mechanical stability. Because of its good availability, however, it can be very advantageous to provide such a glass for the composite glass, specifically optionally on the composite side, which is exposed to lower mechanical stress and/or corrosion in use. In the case of a vehicle pane composed of or comprising a composite glass, this may advantageously be the side of the composite glass facing the interior of the vehicle. This constitutes a good compromise between very good stability of the composite glass and acceptable costs.

In some embodiments, the composite has a level of at least 3 in what is called a “pummel test”. The pummel test is a measure of the strength or the quality of the composite and is described in standard ASTM C1908-21. It is generally the case that, in the event of destruction of the composite, which can also be referred to, for example, as “composite safety glass”, the glass fragments must remain stuck to the polymeric layer, configured as a PVB film, for example, between the glass panes of the composite. This is verified by the “pummel test”, in which a composite glass comprising two glass panes having a maximum thickness of 2*4 mm is worked with a hammer on an inclined metal base, i.e. is pummeled. This destroys the glass by virtue of the mechanical action. This is followed by visual inspection. The adhesion level is classified into “pummel values” between 0 and 10 depending on the film area exposed or area of the polymeric layer exposed, where higher values mean better adhesion of the glass fragments on the polymeric layer.

The disclosure also relates generally to a process for producing a glass pane comprising at least one coating and/or for producing a composite comprising a glass pane comprising at least one coating.

For the production of the glass pane comprising at least one coating, it is generally possible to use a paste comprising a glass flux, at least one pigment and optionally at least one additive, optionally in the form of a filler. In this case, the above remarks relating to the composition of the at least one coating according to embodiments in terms of the pigment and binder content are correspondingly applicable, meaning that the figures for the content are based on the solids content of the paste. As well as the corresponding solids contents in the corresponding amounts, the paste generally additionally comprises between about 30% by weight and 45% by weight of a medium or dispersion medium, generally a high-boiling solvent or solvent mixture. In particular, this may be what is called “screenprinting oil”, especially when the paste is applied to the glass pane by screenprinting.

The paste may be applied by customary coating methods, especially by printing methods such as screenprinting.

It is additionally possible that the paste comprises an additive in the form of a blowing agent.

The composition of the paste, especially with regard to the at least one vitreous constituent, and of the glass used in the glass pane to which the at least one coating is or has been applied are optionally matched to one another such that the baking temperatures and times of the at least one coating optionally correspond to the bending temperatures and times for this pane where it is bent. From a viscosity point of view, the at least one coating in the form of a porous enamel layer is formed at those temperatures at which the pane has a viscosity of lg [η]/dPas of 8-11, optionally 9-10, i.e. at temperatures between optionally at least 590° C. and at most 850° C.

### Examples

The table that follows is a compilation of some compositions of suitable glass panes in embodiments of the disclosure, together with relevant data relating to the properties achieved with these glass compositions. The compositions are each reported in % by weight based on oxide. Variances from 100% in the sums arise from roundings as a result of the analysis.

| Glass number | 1 | 2 | 3 | 4 | 5 | 6 | 7 | 8 |
|---|---|---|---|---|---|---|---|---|
| SiO₂ | 78.00 | 72.10 | 80.80 | 80.30 | 74.80 | 79.00 | 78.10 | 64.00 |
| B₂O₃ | 18.50 | 24.50 | 12.70 | 13.10 | 10.45 | 10.00 | 9.80 | 9.00 |
| Al₂O₃ | 1.00 | 1.10 | 2.40 | 2.50 | 2.50 | 4.30 | 2.50 | 10.50 |
| Li₂O | | 0.40 | | | | | | |
| Na₂O | 2.50 | 1.10 | 3.50 | 3.85 | 2.35 | 5.00 | 2.80 | 5.00 |
| K₂O | | 0.80 | 0.60 | 0.00 | 3.00 | 0.60 | 2.50 | 0.80 |
| MgO | | | | | | | 1.80 | 4.50 |
| CaO | | | | | 2.40 | 1.30 | 2.50 | 3.00 |
| SrO | | | | | | | | 3.20 |
| BaO | | | | | | | | |
| ZnO | | | | | 2.00 | | | |
| TiO₂ | | | | | | | | |
| ZrO₂ | | | | | 2.50 | | | |
| P₂O5 | | | | | | | | |
| Additive (if present) | | | | | | | | |
| SnO₂ | | | | | | | | |
| NaCl | 0.15 | | 0.10 | 0.10 | 0.25 | 0.22 | | 0.25 |
| Total | 100.15 | 100.00 | 100.10 | 99.85 | 100.25 | 100.42 | 100.00 | 100.25 |
| Physical data | | | | | | | | |
| α (*10⁻⁶/K) | 2.80 | 3.29 | 3.25 | 3.22 | 4.10 | 4.11 | 4.15 | 5.50 |
| T_{g} (° C.) | 535 | 467 | 530 | 520 | 590 | 580 | 589 | 615 |
| Density (g/cm³) | 2.18 | 2.13 | 2.22 | 2.22 | 2.35 | 2.28 | 2.31 | 2.44 |
| T14.5 (° C.) | 521 | 505 | 532 | 518 | 545 | 565 | 568 | 593 |
| T11 (° C.) | 627 | 594 | 637 | 631 | 646 | 661 | 669 | 691 |
| T9 (° C.) | 720 | 729 | 729 | 728 | 735 | 746 | 758 | 773 |
| T7.6 (° C.) | 810 | 750 | 818 | 820 | 822 | 830 | 843 | 850 |
| Modulus of elasticity (GPa) | 58 | 52 | 63 | 64 | 70 | 67 | 69 | |
| Hydrolyt. stability H (class) | 1 | 1 | 1 | 1 | 1 | 1 | 1 | |
| Acid stab. S (class) | 1 | 1 | 1 | 1 | 1 | 1 | 1 | |

Illustrative compositions of suitable glass fluxes are found in the table below. Here too, the compositions are reported in % by weight. Any variances from the sum total of 100% by weight are the result of rounding.

| Glass flux number | 1 | 2 | 3 | 4 | 5 | 6 | 7 | 8 | 9 | 10 | 11 |
|---|---|---|---|---|---|---|---|---|---|---|---|
| Al₂O₃ | 8.2 | 7.2 | 5.4 | 0.6 | 5.9 | 0.10 | 1.00 | 5.1 | 5.3 | 5.0 | 2.0 |
| B₂O₃ | 17.5 | 22.8 | 24.0 | 24.6 | 21.5 | 15.7 | 12.8 | 21.9 | 22.9 | 23.4 | 8.3 |
| BaO | | | | | | | | | | | |
| Bi₂O₃ | 14.2 | 10.0 | 10.0 | | | | | | | 11.0 | 43.3 |
| CaO | | | | 1.3 | 1.2 | | | 0.5 | 0.5 | | 0.1 |
| CoO | | | | | 2.9 | | | | | | |
| K₂O | | | | 0.1 | | | | 1.7 | 1.8 | 0.8 | 1.8 |
| Li₂O | | 3.2 | 4.4 | | 4.9 | | | 0.8 | 0.8 | 4.8 | 0.8 |
| MgO | | | | 0.3 | | | | | | | |
| Na₂O | 5.2 | 1.2 | 0.2 | 6.1 | | | | 2.4 | 2.5 | | 2.8 |
| SiO₂ | 54.9 | 55.6 | 56.0 | 66.6 | 58.0 | 32.7 | 24.3 | 63.4 | 66.2 | 55.0 | 29.5 |
| SrO | | | | | 1.0 | | | | | | |
| TiO₂ | | | | | | | | | | | 1.6 |
| ZnO | | | | 0.4 | 3.3 | 51.5 | 62.0 | | | | 8.9 |
| ZrO₂ | | | | | 1.3 | | | | | | 1.1 |

In the table below, suitable pigments for coatings are detailed by embodiments. The specified pigment class is based on the so-called “Color Index”, in which the pigments are classified into classes, where, in the table, “Bk” means “Black”, “Br” means “Brown” and “Gr” means “Green”. The pigments listed are generally suitable for the production of dark layers according to embodiments, especially also for those that cause a black color impression. This is especially also true of the pigments classified as “brown” or “green” in the table, since these generally have such a composition that they are highly absorbing, and this “color” in coatings comprising these pigments often appears usually only in the form of a slight color shade (as brownish or greenish black), if anything, and the general color impression of such a coating is indeed dark or black.

| | | Particle | | | | | |
|---|---|---|---|---|---|---|---|
| | | size | Density | d₁₀ | d₅₀ | d₉₀ | d₉₉ |
| Pigment | | (datasheet)/ | (datasheet)/ | (Mie)/ | (Mie)/ | (Mie)/ | (Mie)/ |
| class | Chemistry | μm | g/cm³ | μm | μm | μm | μm |
| Bk26 | Mn-Fe | 4.1 | 6.9 | 0.26 | 4.27 | 13.21 | 18.58 |
| | ferrite | | | | | | |
| | spinel | | | | | | |
| | (Fe, Mn)₃O₄ | | | | | | |
| Bk26 | (Fe, Mn)₂O₃ | 1 | 5 | | | | |
| Bk27 | Co-Cr-Fe | 0.7 | 5.3 | 0.54 | 0.84 | 1.29 | 1.79 |
| | spinel | | | | | | |
| | (Cr-Fe-Co- | | | | | | |
| | Mn, by | | | | | | |
| | XRF) | | | | | | |
| Bk27 | Cr-Fe-Co | 2.1 | 5.8 | 0.78 | 2.05 | 3.68 | 5.06 |
| | spinel | | | | | | |
| Bk27 | Co-Cr-Fe | 2.6 | | | | | |
| | spinel | | | | | | |
| | (Cr-Fe-Co- | | | | | | |
| | Mn-Ni, by | | | | | | |
| | XRF) | | | | | | |
| Bk28 | Cu-Cr | 0.7 | 5.4 | 0.22 | 0.52 | 1.01 | 1.53 |
| | spinel | | | | | | |
| Bk28 | Cu-Cr | 0.9 | 5.6 | 0.52 | 0.83 | 1.39 | 2.04 |
| | spinel | | | | | | |
| Bk28 | Cu-Cr | 0.77 | | | | | |
| | spinel | | | | | | |
| Bk28 | Co-Cr | 0.92 | | | | | |
| | spinel | | | | | | |
| Bk30 | Ni-Fe-Cr | 1.1 | 5.3 | 0.62 | 0.96 | 1.64 | 2.36 |
| | spinel | | | | | | |
| Bk30 | Ni-Cr-Fe | 0.9 | | | | | |
| | spinel | | | | | | |
| Bk33 | Fe-Mn | 0.6 μm | 4.6 | 0.7 | 1.28 | 2.85 | 5.34 |
| | oxides | | | | | | |
| | (Fe, Mn)₂O₃ | | | | | | |
| Bk33 | Fe-Mn | 0.89 | | | | | |
| | spinel | | | | | | |
| Gr17/Br29* | Cr-Fe | 1.2 | 5.8 | 0.68 | 1.09 | 1.89 | 2.82 |
| | oxide | | | | | | |
| Br29 | Cr-Fe | 0.77 | | | | | |
| | oxide | | | | | | |

Suitable additives for a paste or a coating according to embodiments are found in the following table:

| | Density | Particle | BET | |
|---|---|---|---|---|
| Fillers | (g/cm³) | size (μm) | (m²/g) | α (10⁶/K) |
| β-Eucryptite | 2.35 | 1.2 | | −1.1 to −6.5 |
| Silica (1) | 2.2 | 0.04 | 35-65 | ~0.5 |
| Silica (2) | 2.2 | | 270-330 | ~0.5 |
| CoralPor ® 1000 | 2.4 | 1 | 7-130 | 0.5-1 |
| CoralPor ® 2000 | 2.4 | 1 | | 0.5-1 |
| Blowing agent | | | | |
| | | | Bulk | De- |
| | | Shape of the | density | composition |
| | Pore former | pore formers | (kg/m3) | temp. (° C.) |
| Starch | Rice starch | elongated | | ~200 |
| | Potato starch | rounded | 300 | |
| | Corn starch | rounded | | |
| | Wheat starch | elongated | 550-700 | |
| | Manioc | elongated | | |
| Fructose | | rounded | | 103 |
| Glucose | | | | 146 |
| Maltose | | acicular | | 162.5 |
| Sucrose | | | | from 160 |

Useful fillers are especially low-expansion fillers as listed above in the table, for example silicas. Silicas may be used in different variants, for example in the form of silica having a comparatively compact but small particle shape (silica (1) in the table above) or in the form of a silica having particularly high surface area (silica (2) in the table above). It is generally also possible to use amorphous or crystalline fillers that are themselves in porous form, for example the fillers specified above as “CoralPor”. These are fillers composed of porous borosilicate glass. Other fillers are conceivable, for example zeolites in porous and crystalline form, or else other low-expansion fillers beyond β-eucryptite, for example cordierite. The addition of fillers is also very efficient in the improvement of double-ring flexural strength; even an addition of only 1.75% by volume (based on the resulting coating) of a filler leads to an improvement in strength (double-ring flexural tensile strength) compared to a paste/coating of otherwise identical composition but without filler of between 12.5% and 14.5%. Fillers used here were “silica (1)”, β-eucryptite and a CoralPor® filler.

In the case of the blowing agents, inorganic and organic blowing agents are generally possible, although organic blowing agents may be preferred, for example sugars (maltose, glucose or the like) or starches, as also detailed above. If such blowing agents (or else pore formers) are added, this is also manifested, for example, in terms of the strength of the glass pane and correspondingly also of the resulting composite, as well as the positive effect on color, in an improvement in strength (double-ring flexural tensile strength) of more than 40% (starch as blowing agent/pore former) by comparison with a coating of the same composition but without pore former/blowing agent, or more than 30% (sugar). 10% by volume of pore former/blowing agent was added here to the paste. This leads to 10% by volume more pores in the coating than would be the case without addition of blowing agent.

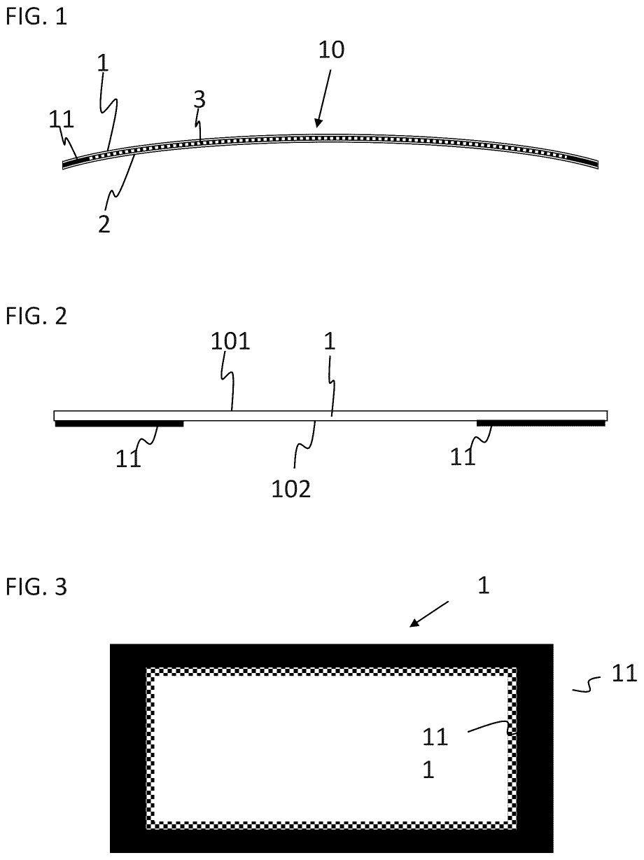

FIG. 1 is a schematic diagram, not to scale, of a composite or a composite glass 10 according to one embodiment of the present disclosure. The composite glass 10 comprises two glass panes 1, 2. Pane 1 here is the at least one glass pane having at least one coating applied in regions. Pane 2 is a further glass pane and may be formed, for example, from a soda-lime glass. A polymeric layer 3 is disposed between the two glass panes 1, 2, here in the region of the composite glass 10, the coating 11. This is disposed on one side (not labelled) of the glass pane 1 and may in each case, in the context of the description that follows, comprise the at least one coating or the at least one coating together with optionally a further coating as interlayer.

For reasons of better illustration, the coating 11 has been represented here as a thick coating, i.e. comparable in terms of thickness to that of the two panes 1, 2; but this, as stated, is merely for better illustration. The coating 11 is generally much thinner than each of the two panes 1, 2 and is generally also thinner than the polymeric layer 3. The polymeric layer 3 may also be a film. Illustrative thicknesses of the polymeric layer are between 650 and 850 μm, where the at least one coating typically has thicknesses in the single-digit micrometre range. An upper limit for the layer thickness of the at least one coating is, for example, 7 μm or 6 μm. In addition, the at least one coating may, for example, be between 3 μm and 5 μm thick.

The composite glass 10 here, as can be seen, takes the form of a curved composite glass pane, as also usable, for example, as the windscreen. In general, without restriction to the example shown in FIG. 1, however, it is also possible that the composite glass 10 does not comprise curved panes 1, 2, but is flat. It is also possible that the curvature of the composite glass 10 is the exact opposite of the diagram shown in FIG. 1. In the example of FIG. 1, the glass pane 1 would be the outside of a windscreen, but it is generally also possible that the glass pane 1 is disposed on the inside of a windscreen. In any case, however, the coating 3 is disposed between the two glass panes 1, 2.

However, the diagram according to FIG. 1 is preferred since, in this way, the first glass pane 1, for example in the case of use as a windscreen, would be exposed to stone-chipping or to chemical stresses such as a salt spray mist, which are better tolerated by a borosilicate glass pane than, for example, a conventional soda-lime glass pane. As also stated further up, however, for reasons of cost, it may be advantageous if not both panes of the composite glass comprise borosilicate glass.

An arrangement as in FIG. 1 may thus be advantageous as stated, since the glass pane 1 comprises SiO₂ and B₂O₃ as components of the vitreous material. Such a borosilicate glass is more scratch-resistant than, for example, a soda-lime glass, and so it can be advantageous when the glass pane 1, as shown in FIG. 1, is formed in the composite 10 such that it faces “outward”, i.e. would point outward in the case of use as a windscreen. This is because this would result in better protection from stone-chipping and similar mechanical stresses.

In order to elucidate the structure of the glass pane 1 according to embodiments, this is shown in FIG. 2 in the form of a schematic diagram, not to scale. FIG. 2 shows a side view. However, the glass pane 1 is shown here in as yet unbent form. In general, without restriction to the example of a glass pane 1 or of a composite glass 10 shown in FIG. 1, it is also possible that the glass pane is in curved form. However, it may be advantageous when a flat, uncurved pane 1 is first used, and this is then bent at a later stage, specifically for example in a thermal method. Here too, for reasons of better illustration, the thickness of the coating 11 is shown as being much greater than in reality.

The arrangement of the pane 1 corresponds to that in FIG. 1, as stated with the exception that the pane in FIG. 2 is not in bent form. As can be seen, the coating 11 here is formed on the side 102 that faces the second pane 2 in the composite 10. Not depicted here is the polymeric layer 3 disposed between the pane 1 and the pane 2 in the composite. It is explicitly pointed out here that the polymeric layer 3 both makes direct contact with the side 102 of the pane and is disposed atop the coating 11 disposed in the region (or the regions) of the pane 1 (or of the side 102 of the pane 1).

The coating 11 is arranged here in the edge region of the pane 1, on the left and on the right respectively in the diagram of FIG. 2. It may be the case here, for example, that the coating overall has been applied in the form of a “frame”.

In this regard, reference is made to FIG. 3, which shows in a likewise schematic diagram, not true to scale, a top view of a composite glass 10 according to one embodiment. The coating 11 here takes the form of a frame running around the edge of the pane 1, with the coating at first in masking form, i.e. in the form of an uninterrupted layer, and merging into the uncoated region via a dot pattern 111 toward the middle of the pane 1. For the case of use of the pane 1 in a composite glass 10, this uncoated region is the viewing region, for example of a windscreen. It is of course generally possible that the frame is not as uniform as shown schematically in FIG. 3, but, for example, has bulges, as is frequently the case, for example, in the windscreens in the region of the rear-view mirrors.

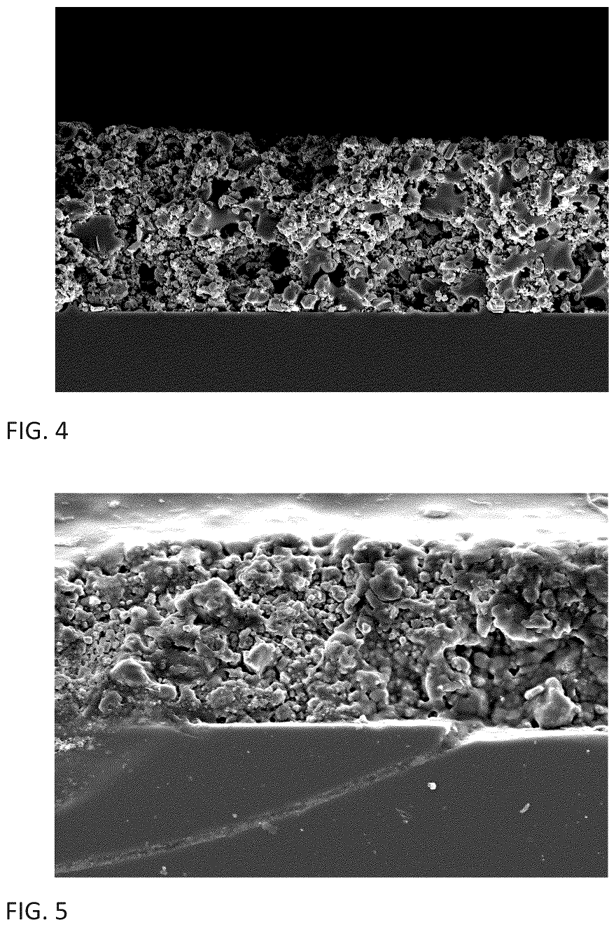

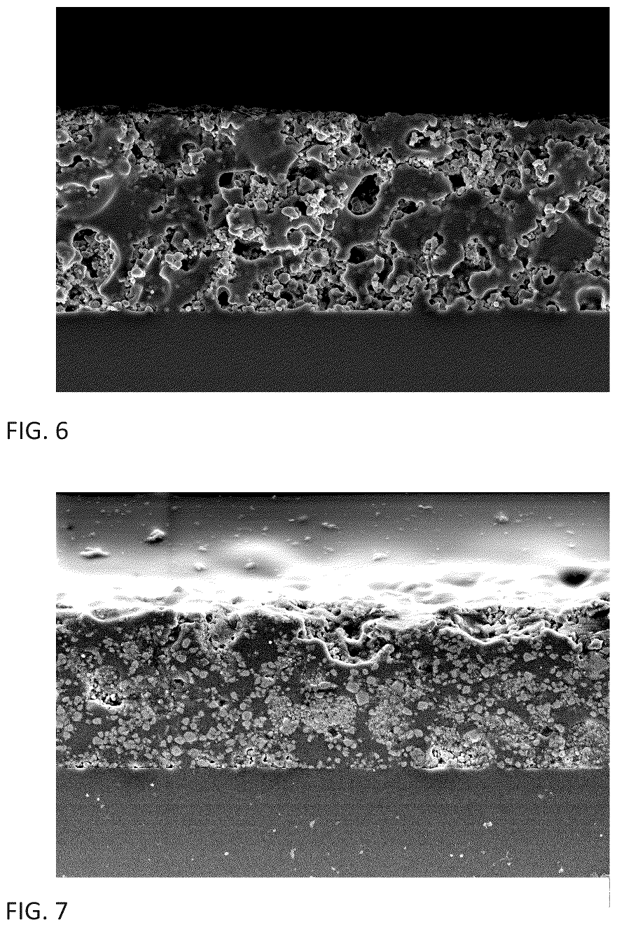

FIGS. 4 and 6 are scanning electron micrographs of glass panes coated in regions and comprising a glass comprising SiO₂ and B₂O₃, which have a first side and a second side, according to embodiments of the disclosure.

The coating here is generally at least one coating applied in at least one region of the second side of the glass pane. It generally takes the form of an enamel coating comprising at least one pigment, a vitreous constituent and optionally at least one additive, for example a filler.

As can be seen, the at least one coating comprises pores, optionally open pores, as can be inferred from the diagram in FIGS. 4 and 6. The result here is therefore optionally a direct bond in the at least one coating between a side of the at least one coating facing the second side of the at least one glass pane and a side of the at least one coating remote from the second side of the at least one glass pane.

As can be inferred from the diagrams of the laminated samples in FIGS. 5 and 7 (where FIG. 5 is the laminated sample from FIG. 4 and FIG. 7 the laminated sample from FIG. 6), the polymeric layer at least partly infiltrates the pores of the at least one coating in the lamination process.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE NUMERALS

| | |
|---|---|
| 1 | Glass pane |
| 10 | Composite, composite pane |
| 11 | Coating |
| 101, 102 | Sides of the glass pane |
| 111 | Dot pattern |
| 2 | Further glass pane |
| 3 | Polymeric layer |

What is claimed is:

1. A composite glass, comprising:
two glass panes, wherein at least one glass pane is a glass pane having coated regions and comprising a glass comprising SiO₂ and B₂O₃ and having a first side and a second side;
at least one coating applied in at least one region of the second side of the at least one glass pane, wherein the at least one coating takes the form of an enamel coating comprising at least one pigment and a vitreous constituent, wherein the at least one coating comprises pores; and
at least one polymeric layer disposed between the glass panes, wherein a polymer in the at least one polymeric layer is in uncolored form, and wherein at least a portion of the at least one polymeric layer in the at least one region of the at least one coating at least partly fills the pores of the at least one coating so as to result in a color locus of the composite glass, determined in viewing direction from the first side to the second side of the at least one glass pane, in the at least one region in which the at least one coating has been applied on the second side of the at least one glass pane, given in the CIEL*a*b* system where L* is at most and a* and b* are each in a range between +5 and −5.

2. The composite glass of claim 1, wherein the at least one coating comprises at least one additive in the form of a filler.

3. The composite glass of claim 2, wherein the filler has a coefficient of linear thermal expansion between −7*10⁻⁶/K and 1.5*10⁻⁶/K.

4. The composite glass of claim 2, wherein a content of the filler is between 0.5% by volume and 20% by volume.

5. The composite glass of claim 1, wherein the pores are open pores so as to result in a direct connection in the at least one coating between a side of the at least one coating facing the second side of the at least one glass pane and a side of the at least one coating remote from the second side of the at least one glass pane.

6. The composite glass of claim 1, wherein the at least one glass pane has a flexural strength between at least 5 and at most 170 MPa.

7. The composite glass of claim 1, wherein L* is at least 1.

8. The composite glass of claim 1, wherein a transmittance, τᵥᵢₛ, determined in the at least one region, is less than 5%.

9. The composite glass of claim 1, wherein at least one of the following is satisfied:
a pigment content of the at least one coating is between 1% by volume and 40% by volume; or
a content of vitreous constituent in the at least one coating, based on a solids content of the at least one coating, is between 60% by volume and 95% by volume.

10. The composite glass of claim 1, wherein the vitreous constituent of the at least one coating comprises, given in % by weight based on oxide:

| | |
|---|---|
| SiO₂ | 10 to 70; and |
| B₂O₃ | 5 to 30. |

11. The composite glass of claim 10, wherein the vitreous constituent of the at least one coating comprises, in % by weight based on oxide:

| | |
|---|---|
| SiO₂ | 10 to 50; |
| B₂O₃ | 10 to 26; and |
| ZnO | 20 to 50. |

12. The composite glass of claim 11, wherein a sum total of alkali metal oxides is between less than 0.5% by weight and 10% by weight and/or a sum total of alkaline earth metal oxides is between 0% by weight and 2.5% by weight.

13. The composite glass of claim 10, wherein the vitreous constituent of the at least one coating comprises, in % by weight based on oxide:

| | |
|---|---|
| SiO₂ | 30 to 60; |
| B₂O₃ | 15 to 25; and |
| Bi₂O₃ | 8 to 45. |

14. The composite glass of claim 13, wherein a sum total of alkali metal oxides is between 3.5% by weight and 8.5% by weight and/or a sum total of alkaline earth metal oxides is 0.5% by weight or less.

15. The composite glass of claim 10, wherein the vitreous constituent of the at least one coating comprises, in % by weight based on oxide:

| | |
|---|---|
| SiO₂ | 50 to 70; |
| B₂O₃ | 15 to 30; |
| Bi₂O₃ | 0 to 15; and |
| ZnO | 0 to 5. |

16. The composite glass of claim 15, wherein a sum total of alkali metal oxides is between 4 and 6.5% by weight and/or a sum total of alkaline earth metal oxides is between 0 and 2.5% by weight.

17. The composite glass of claim 1, wherein the at least one glass pane comprises at least 60% by weight and at most 85% by weight of SiO₂, at least 8% by weight and at most 26% by weight of B₂O₃, at least 0.5% by weight and at most 12% by weight of Al₂O₃ and at least 0.5% by weight and at most 6% by weight of Na₂O.

18. The composite glass of claim 17, wherein at least one glass pane comprises up to 1% by weight of Li₂O, up to 4% by weight of K₂O, up to 5% by weight of MgO, up to 3.5% by weight of CaO, up to 4% by weight of SrO, up to 3% by weight of ZnO, up to 3% by weight of ZrO₂, and a sum total of secondary constituents that is not more than 2% by weight.

19. The composite glass of claim 1, wherein the two glass panes comprise the at least one glass pane and a further glass pane that comprises or consists of a soda-lime glass.

20. The composite glass of claim 1, having a result of at least 3 in a pummel test described in standard ASTM C1908-21.
